(19) United States
(12) Patent Application Publication
(10) Pub. No.: US 2019/0263180 A1
(43) Pub. Date: Aug. 29, 2019

(54) Tire With Steel Cord-Containing Ply

(71) Applicant: Bridgestone Americas Tire Operations, LLC, Nashville, TN (US)

(72) Inventors: Carlie M. Sherhag, Canfield, OH (US); Timothy F. Robinson, North Canton, OH (US); David J. Zemla, Canal Fulton, OH (US)

(21) Appl. No.: 16/287,193

(22) Filed: Feb. 27, 2019

Related U.S. Application Data
(60) Provisional application No. 62/636,203, filed on Feb. 28, 2018.

(51) Int. Cl. B60C 9/18; B60C 9/00; D07B 1/06; D02G 3/48

(52) U.S. Cl. CPC B60C 9/1807; B60C 9/0007; B60C 9/0042; D07B 1/062; D02G 3/48; D07B 2205/3025; D10B 2331/02; D10B 2331/021; D10B 2331/04; D10B 2201/20; B60C 2009/0085

(57) ABSTRACT

Disclosed herein are vehicle tires including a carcass with at least one body ply, a tread disposed radially outward of the carcass, and a belt component comprising a steel cord-containing ply positioned radially between the tread and the carcass. The steel cord-containing ply comprises rubber reinforced with steel warp cords having a specified diameter and EASL. Also disclosed is a vehicle tire containing two belt components comprising a steel cord-containing ply, each belt component positioned radially between the tread and the carcass.

### CROSS REFERENCE TO RELATED APPLICATION

This application claims priority to U.S. Provisional Application Ser. No. 62/636,203, filed Feb. 28, 2018, which is hereby incorporated by reference in its entirety.

### FIELD

The present application is directed to vehicle tires comprising a steel cord-containing ply positioned radially between the tire tread and the carcass wherein the ply comprises rubber reinforced with steel warp cords connected with pick cords having particular properties.

### BACKGROUND

Tires are comprised of various components including one or more plies that are reinforced with metallic or textile-based cords. Generally, the plies are covered in rubber prior to being incorporated into the tire. Depending upon the type of tire, one or more cord-containing plies may be included in the components such as a belt, a body ply, or a cap.

### SUMMARY

Disclosed herein are vehicle tires comprising a steel cord-containing ply which comprises rubber reinforced with steel warp cords connected with pick cords having particular properties. Taking into account that the tire includes a carcass which includes at least one body ply, a tread disposed radially outward of the carcass, and a belt component, the steel cord-containing ply can be understood as a part of the belt component and is positioned radially between the tread and the carcass.

In a first embodiment, a vehicle tire is disclosed which includes a carcass with at least one body ply, a tread disposed radially outward of the carcass and a belt component comprising a steel cord-containing ply positioned radially between the tread and the carcass. According to the first embodiment, the steel cord-containing ply comprises rubber reinforced with steel warp cords having a diameter of 0.3 to 7 mm, wherein the steel warp cords are connected with pick cords having a specified EASL. Further according to the first embodiment, the steel warp cords are non-intersecting.

In a second embodiment, a vehicle tire is disclosed which includes a carcass with at least one body ply, a tread disposed radially outward of the carcass, and two belt components each comprising a steel cord-containing ply, each belt component positioned radially between the tread and the carcass. According to the second embodiment, the steel cord-containing ply comprises rubber reinforced with steel warp cords having a diameter of 0.3 to 7 mm, wherein the steel warp cords are connected with pick cords having a specified EASL. Further according to the second embodiment, the steel warp cords of each steel cord-containing ply are non-intersecting.

### DETAILED DESCRIPTION

Disclosed herein are vehicle tires comprising a steel cord-containing ply which comprises rubber reinforced with steel warp cords connected with pick cords having particular properties. Taking into account that the tire includes a carcass which includes at least one body ply, a tread disposed radially outward of the carcass, and a belt component, the steel cord-containing ply can be understood as a part of the belt component and is positioned radially between the tread and the carcass.

In a first embodiment, a vehicle tire is disclosed which includes a carcass with at least one body ply, a tread disposed radially outward of the carcass and a belt component comprising a steel cord-containing ply positioned radially between the tread and the carcass. According to the first embodiment, the steel cord-containing ply comprises rubber reinforced with steel warp cords having a diameter of 0.3 to 7 mm, wherein the steel warp cords are connected with pick cords having a specified EASL. Further according to the first embodiment, the steel warp cords are non-intersecting.

In a second embodiment, a vehicle tire is disclosed which includes a carcass with at least one body ply, a tread disposed radially outward of the carcass, and two belt components each comprising a steel cord-containing ply, each belt component positioned radially between the tread and the carcass. According to the second embodiment, the steel cord-containing ply comprises rubber reinforced with steel warp cords having a diameter of 0.3 to 7 mm, wherein the steel warp cords are connected with pick cords having a specified EASL. Further according to the second embodiment, the steel warp cords of each steel cord-containing ply are non-intersecting.

### Definitions

The terminology as set forth herein is for description of the embodiments only and should not be construed as limiting the invention as a whole.

As used herein, the terms “axial” and “axially,” refer to a direction that is parallel to the axis of rotation of a tire.

As used herein, the term “cap” should be understood to include both a cap ply which is in the shoulder areas of the tire and extends the entire width of the crown portion of a tire as well as a cap ply layer which is only in the shoulder areas of the tire.

As used herein, “circumferential” and “circumferentially,” refer to a direction extending along the perimeter of the surface of the annular tread perpendicular to the axial direction.

As used herein, the term “cord” refers to a strand made of a metallic or non-metallic material. An individual cord may be comprised of multiple filaments.

As used herein, the term “denier” refers to the weight per length of a filament or cord in units of grams per 9000 meters.

As used herein, the terms “radial” and “radially,” refer to a direction perpendicular to the axis of rotation of a tire.

As used herein, the term “sidewall,” refers to the portion of the tire between the tread and the bead.

As used herein, the term “steel” as used in the phrase “steel cords” should be understood to include steel alloys.

As used herein, the term “tread,” refers to both the portion of a tire that comes into contact with the road under normal inflation and load as well as any subtread.

As used herein, the term “vehicle” refers to a wheeled-apparatus used to convey goods and/or people.

### Vehicle Tires

As discussed above, the first and second embodiments disclosed herein are directed to vehicle tires comprising a steel cord-containing ply which comprises rubber reinforced with steel warp cords connected with pick cords having particular properties. The particular type of vehicle for which the tires are design for use upon may vary. Non-limiting examples of suitable vehicles include passenger cars, light trucks (e.g., Ford F-150, F-1250 and F-350), semi-trucks, motorcycles, mining equipment, and farm and agricultural equipment. In certain embodiments of the first and second embodiments, the vehicle tire is a passenger car tire or a light truck tire.

In certain embodiments of the first and second embodiments, the vehicle tire is a pneumatic tire. In other embodiments of the first and second embodiments, the vehicle tire is a semi-pneumatic tire. In yet other embodiments of the first and second embodiments, the vehicle tire is a non-pneumatic (e.g., a tire which can be re-treaded).

### Steel Cord-Containing Ply

As discussed above, according to the first and second embodiments, the belt component(s) of the vehicle tire comprises (includes) a steel cord-containing ply positioned radially between the tread and the carcass. It is contemplated that use of the steel cord-containing ply or plies may, in certain preferred embodiments, allow for the elimination of a cap. In such embodiments, the vehicle tire is devoid of or does not include a cap. In other embodiments of the first and second embodiments, the vehicle tire also includes (further comprises) a cap, which when present is positioned between the steel cord-containing ply and the tread (the tread should be understood as including not only the road-contacting portion of the tread but also any sub-tread such that any cap ply is located radially inward of (and adjacent to) the subtread and radially outward of (and adjacent to) the steel cord-containing ply of the belt component. In certain such embodiments, the cap is a cap ply. In other such embodiments, the cap is a cap layer. In those embodiments where the vehicle tire includes a cap in addition to the steel cord-containing ply or plies, a lighter-weight cap (e.g., containing smaller cords) may be utilized. According to the first and second embodiments, the steel cord-containing ply will generally extend the entire width of the crown portion of the tire, but will not extend beyond the crown into the shoulder.

As discussed above, according to the first and second embodiments, the tire includes a belt component (first embodiment) or two belt components (second embodiment), the belt component(s) comprising a steel cord-containing ply or plies comprising rubber reinforced with steel warp cords. The steel cord-containing ply comprises warp and pick cords (as described in more detail elsewhere herein) and rubber which covers both the top and bottom surfaces of the cords. Generally, according to the first and second embodiments, the steel cord-containing ply is wrapped circumferentially around the tire circumference. In other words, the tire of the first and second embodiments is prepared by utilizing a length of the steel cord-containing ply sufficient to cover the circumference of the tire. According to the first and second embodiments, the steel cord-containing ply will generally be oriented in the tire so that the warp cords are positioned are positioned at an angle of about 10 to about 40 degrees, preferably about 15 to about 38 degrees from the direction of circumferential forward travel of the tire. In certain embodiments of the first and second embodiments, the single steel cord-containing ply is generally oriented in the tire with the warp cords positioned at an angle of 10-40 degrees (e.g., 10, 15, 20, 25, 30, 35, or 40 degrees), or at an angle of 15-38 degrees (e.g., 15, 20, 25, 30, 32, 34, 36, or 38 degrees) from the direction of circumferential forward travel of the tire.

According to the first and second embodiments, the steel cord-containing ply has its outer surfaces (i.e., top and bottom) almost entirely or entirely enveloped in rubber (i.e., a rubber composition). By almost entirely or entirely enveloped is meant that both outer surfaces of the cords are at least 95% covered with the rubber composition, preferably a continuous length of at least 16 cm of the steel cord-containing ply (or a section of the ply of at least 40 cm²) meets the foregoing. Accordingly, in certain embodiments, at least 95% of the outer surfaces (top and bottom surfaces) are covered with rubber, including at least 96%, at least 97%, at least 98%, at least 98.5%, at least 99%, at least 99.5%, at least 99.8%, at least 99.9% and even 100%.

The particular composition of the rubber used in preparing the steel cord-containing ply of the first and second embodiments may vary and generally natural rubber, synthetic rubber(s), or a combination thereof may be utilized. Preferred synthetic rubbers include those based upon at least one conjugated diene monomer optionally in combination with a vinyl aromatic monomer. In certain embodiments of the first and second embodiments, the rubber comprises at least one of natural rubber, polyisoprene, styrene-butadiene copolymer, or polybutadiene. Preferred polybutadiene rubbers are those having a cis-1,4-bond content of at least 92% and in certain instances at least 96%. Exemplary conjugated dienes include 1,3-butadiene, 2-methyl-1,3-butadiene-(isoprene), 2,3-dimethyl-1,2-butadiene, 1,3-pentadiene, 1,3-hexadiene and the like as well as mixtures of the foregoing, with 1,3-butadiene being preferred. Exemplary vinyl aromatic monomers include styrene, alpha-methyl styrene, vinyl naphthalene, vinyl pyridine and the like as well as mixtures of the foregoing with styrene being preferred. The practice of the first and second embodiments disclosed herein is not necessarily limited to any particular rubber identified hereinabove.

In certain embodiments of the first and second embodiments, the rubber of the steel cord-containing ply further comprises one or more fillers, as discussed below. Exemplary fillers include reinforcing fillers such as carbon blacks, talc's, silica and other finely divided mineral materials. Carbon black and silica are particularly preferred, and may be used alone or in combination. Silica and other filler materials excluding carbon black are optionally compounded with the rubber(s) in amounts ranging from 0 to about 80 parts by weight, per 100 parts of rubber (phr). In those embodiments where carbon black is utilized, suitable amounts include about 5 to about 100 parts by weight, per 100 parts of rubber (phr), with about 5 to about 80 phr being preferred and from about 40 to about 70 phr being more preferred. The carbon blacks may include any of the commonly available, commercially-produced carbon blacks but those having a surface area (EMSA) of at least 20 m²/g, preferably at least 35 m²/g up to 200 m²/g, or 35 m²/g up to 100 m²/g are preferred (with surface area values used in this application being determined by ASTM test D-1765 using the cetyltrimethyl-ammonium bromide (CTAB) technique).

In certain embodiments of the first and second embodiments, the rubber of the steel cord-containing ply further comprises one or more adhesion promoting compounds which facilitate the bonds of the underlying steel cords to the overlying rubber composition. In certain such embodiments, the adhesion promoting compound is a metal complex, preferably a metal (e.g., cobalt, zinc, potassium, aluminum, titanium, zirconium, or molybdenum) salt of an organic acid (e.g., neodecanoic acid, stearic acid, naphthenic acid, rosin, tall oil acid, oleic acid, linoleic acid, linolenic acid and the like). In certain embodiments, the adhesion promoting compound comprises a cobalt salt of an organic acid (e.g., cobalt neodecanoate). In certain embodiments of the first and second embodiments, instead of the rubber including one or more adhesion promoting compounds, the steel cords are coated or otherwise treated with one or more such compounds (such as those discussed above) prior to being covered with rubber. In certain embodiments of the first and second embodiments, both the steel cords and the overlying rubber composition contain one or more of adhesion promoting compounds, such as those discussed above.

The rubber of the steel cord-containing ply is generally cured by sulfur and thus, a sulfur curing agent, such as sulfur or a sulfur donor may be added. Generally, 0.1 to 10 phr, including from 1 to 7.5 phr, including from 1 to 5 phr, and preferably from 1 to 3.5 phr of sulfur, or an equivalent amount of sulfur donor, is added to the rubber composition. One or more cure accelerators may also be utilized in a total amount of 0.1 to 10 phr, preferably 0.5 to 5 ph. The rubber composition may also include from 1 to 3 phr of an antioxidant. Optionally, the rubber composition further comprises 0.1 to 10 phr, preferably 0.5 to 5 phr, of a compound selected from the group consisting of aminosilanes and mercaptosilanes. An adhesion promoter can optionally be added to the rubber composition in order to improve adhesion between the rubber and the steel warp cords. Suitable adhesion promoters are well known and include, but are not limited to, cobalt-containing compounds, resorcinol compounds, and hydrocarbon resins in an amount of 1 to 10 phr or 1 to 5 phr.

In certain embodiments of the first and second embodiments the rubber composition is formed into sheets that are used to cover the top and bottom surface of the cords of the steel cord-containing ply. The thickness of the rubber sheets may vary depending upon factors including the diameter of the warp cords used in the steel cord-containing ply with relatively larger warp cords generally requiring relatively thicker rubber sheets. In certain embodiments of the first and second embodiments, the rubber sheets used to cover the top and bottom surface of the cords of the steel cord-containing ply have a thickness of at least 0.5 mm. In certain embodiments of the first and second embodiments, the rubber sheets used to cover the top and bottom surface of the cords of the steel cord-containing ply have a thickness of 0.5 mm to 15 mm (e.g., 0.5 mm, 0.6 mm, 0.7 mm, 0.8 mm, 0.9 mm, 1 mm, 1.1 mm, 1.2 mm, 1.3 mm, 1.4 mm, 1.5 mm, 1.6 mm, 1.7 mm, 1.8 mm, 1.9 mm, 2 mm, 3 mm, 4 mm, 5, mm, 6 mm, 7 mm, 8 mm, 9 mm, 10 mm, 11 mm, 12 mm, 13 mm, 14 mm, 15 mm), preferably 0.5 to 3 mm. In certain embodiments of the first and second embodiments, the overall thickness of the single steel cord-containing ply is at least 1 mm, including 1.5-35 mm (e.g., 1.5, 2, 3, 4, 5, 10, 15, 20, 25, 30, or 35 mm), 2-35 mm, 5-35 mm, 10-35 mm, 1.5-30 mm, 2-30 mm, 5-30 mm, 10-30 mm, 1.5-25 mm, 2-25 mm, 5-25 mm, 10-25 mm, 1.5-20 mm, 2-20 mm, 5-20 mm, 10-20 mm, 1.5-15 mm, 2-15 mm, 5-15 mm, and 10-15 mm.

Steel Warp Cords

As discussed above, the steel cord-containing ply according to the first and second embodiments comprises rubber reinforced with steel warp cords. According to the first and second embodiments, the steel warp cords have a diameter of about 0.3 to about 7 mm. In certain embodiments of the first and second embodiments, the steel warp cords have a diameter of 0.3 to 7 mm (e.g., 0.3, 0.35, 0.4, 0.45, 0.5, 0.55, 0.6, 0.65, 0.7, 0.75, 0.8, 0.85, 0.9, 0.95, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 5, 5.1, 5.2, 5.3, 5.4, 5.5, 5.6, 5.7, 5.8, 5.9, 6, 6.1, 6.2, 6.3, 6.4, 6.5, 6.6, 6.7, 6.8, 6.9, or 7 mm), about 0.4 to about 6 mm, or 0.4 to 6 mm (e.g., 0.4, 0.45, 0.5, 0.55, 0.6, 0.65, 0.7, 0.75, 0.8, 0.85, 0.9, 0.95, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 5, 5.1, 5.2, 5.3, 5.4, 5.5, 5.6, 5.7, 5.8, 5.9, or 6 mm). In preferred embodiments of the first and second embodiments, the steel warp cords have a circular cross-section. In other embodiments of the first and second embodiments, the steel warp cords have a non-circular or oval cross-section by which is meant that their width and thickness vary by more than 10% (e.g., 10%, 15%, 20%, 25%, 30%, 35%, 40%, 45%, 50%, 55%, 60%, 65%, or 70%)) up to about 70%. In certain such embodiments, the steel warp cords have an oval cross-section in which their width and thickness vary by 30% to 50% (e.g., 30%, 32%, 34%, 36%, 38%, 40%, 42%, 44%, 46%, 48%, or 50%). Preferably, the steel warp cords of the first and second embodiments are not flat and do not have a width which varies by more than 75% from their thickness. Preferably, the steel warp cords of the first and second embodiments are not crimped. Crimped cords can be considered to be cords which extend out of a flat plane such as by 10 degrees or more. Preferably, all of the warp cords within the steel cord-containing belt ply are metallic. In other words, in such embodiments, the warp cords cannot be considered to be non-metallic. Exemplary non-metallic materials include glass, polyester, nylon, other polymers and cotton. Preferably, all of the steel warp cords within a given belt ply of the first and second embodiment are made of the same material (i.e., all of the warp cords are steel rather than some of the warp cords being steel and other of the warp cords being made of a non-metallic material).

According to the first and second embodiments, the steel warp cords are non-intersecting to each other. In other words, the steel warp cords are positioned within the steel cord-containing ply in substantially parallel arrangement such that within the ply they do not cross over or intersect each other along their length. In certain embodiments of the first and second embodiments, each steel warp cord can be described as positioned parallel to the other steel warp cords within the steel cord-containing ply. In preferred embodiments of the first and second embodiments, the steel cord-containing ply contains multiple steel warp cords which are positioned parallel to each other or substantially parallel to each other, as discussed above. In other words, in such embodiments, the single steel cord-containing belt ply does not include a warp which is a continuous steel cord.

According to the first and second embodiments, the spacing between the steel warp cords may vary in different steel cord-containing plies. As used herein, spacing between steel warp cords refers to spacing between adjacent warp cords in a ply. However, generally, within a given ply the spacing between steel warp cords will be the same. In certain embodiments of the first and second embodiments, the spacing between the steel warp cords is about 0.3 to about 4 mm. In certain embodiments of the first and second embodiments, the spacing between the steel warp cords is 0.3 to 4 mm (e.g., 0.3, 0.35, 0.4, 0.45, 0.5, 0.55, 0.6, 0.65, 0.7, 0.75, 0.8, 0.85, 0.9, 0.95, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, or 4 mm), about 0.35 to about 3 mm or 0.35 to 3 mm (e.g., 0.35, 0.4, 0.45, 0.5, 0.55, 0.6, 0.65, 0.7, 0.75, 0.8, 0.85, 0.9, 0.95, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, or 3 mm).

According to the first and second embodiments, the steel warp cords of the steel cord-containing ply may be formed of one or more than one filament. Preferably, the steel warp cords are formed from more than one filament. According to the first and second embodiments, when the steel warp cords are formed from more than one filament, the particular number of filaments and their configuration may vary. In certain embodiments of the first and second embodiments, the steel warp cords have a construction of M×N where M is an integer of 1-7 (i.e., 1, 2, 3, 4, 5, 6, or 7), and N is either an integer of 2-10 (i.e., 2, 3, 4, 5, 6, 7, 8, 9, or 10) or selected from (O+P) where O is an integer of 1-4 (i.e., 1, 2, 3, or 4) and P is an integer of 5-15 (i.e., 5, 6, 7, 8, 9, 10, 11, 12, 13, 14, or 15). In certain such embodiments, M is an integer of 2-7 (i.e., 2, 3, 4, 5, 6, or 7) or 1-5 (i.e., 1, 2, 3, 4, or 5); N is either an integer of 2-10 (i.e., 2, 3, 4, 5, 6, 7, 8, 9, or 10) or 2-8 (i.e., 2, 3, 4, 5, 6, 7, or 8) or N is selected from (O+P) where O is an integer of 1-3 (i.e., 1, 2, or 3) to 2-4 (i.e., 2, 3, or 4) and P is an integer of 5-10 (i.e., 5, 6, 7, 8, 9, or 10) or 7-15 (i.e., 7, 8, 9, 10, 11, 12, 13, 14, or 15). The diameter of the filament or filaments forming the steel warp cord may vary. In other embodiments of the first and second embodiments, the steel warp cords contain filaments configured in a different construction. In certain embodiments of the first and second embodiments, each filament has a diameter of about 0.1 to about 0.5 mm or 0.1-0.5 mm (e.g., 0.1, 0.11, 0.12, 0.13, 0.14, 0.15, 0.16, 0.17, 0.18, 0.19, 0.2, 0.21, 0.22, 0.23, 0.24, 0.25, 0.26, 0.27, 0.28, 0.29, 0.3, 0.31, 0.32, 0.33, 0.34, 0.35, 0.36, 0.37, 0.38, 0.39, 0.4, 0.41, 0.42, 0.43, 0.44, 0.45, 0.46, 0.47, 0.48, 0.49, or 0.5 mm), preferably about 0.15 to about 0.4 mm or 0.15 to 0.4 (e.g., 0.15, 0.16, 0.17, 0.18, 0.19, 0.2, 0.21, 0.22, 0.23, 0.24, 0.25, 0.26, 0.27, 0.28, 0.29, 0.3, 0.31, 0.32, 0.33, 0.34, 0.35, 0.36, 0.37, 0.38, 0.39, 0.4 mm).

According to the first and second embodiments, the type (composition) of steel used in the warp cords may vary. In certain embodiments of the first and second embodiments, the steel warp cords are comprised of a high carbon steel having a content of 0.6-1 weight % (e.g., 0.6, 0.65, 0.7, 0.75, 0.8, 0.85, 0.9, 0.95, or 1 weight %) carbon or 0.7-0.85 weight % carbon.

Pick Cords

As discussed above, the steel cord-containing ply according to the first and second embodiments comprises rubber reinforced with steel warp cords connected with pick cords having an EASL according to one of the following: (1) for PET pick cords having a total denier up to 2000 (which should be understood as including 2000), the EASL at 44 N is at most 4% (e.g., 4%, 3.9%, 3.8%, 3.7%, 3.6%, 3.5%, 3%, 2.5%, 2%, etc.), preferably no more than 3.5% (e.g., 3.5%, 3.4%, 3.3%, 3.2%, 3.1%, 3%, 2.5%, 2%, etc.), or no more than 3% (e.g., 3%, 2.9%, 2.8%, 2.7%, 2.6%, 2.5%, 2%, etc.), (2) for PET pick cords having a total denier of 2001-3000, the EASL at 66 N is at most 5% (e.g., 5%, 4.9%, 4.8%, 4.7%, 4.6%, 4.5%, 4%, 3.5%, etc.), preferably no more than 4.5% (e.g., 4.5%, 4.4%, 4.3%, 4.2%, 4.1%, 4%, 3.5%, etc.); (3) for nylon pick cords having a total denier up to 1500 (which should be understood as including 1500), the EASL at 33 N is at most 9.5% (e.g., 9.5%, 9.4%, 9.3%, 9.2%, 9.1%, 9%, 8.5%, 8%, 7.5%, etc.), preferably no more than 9% (e.g., 9%, 8.9%, 8.8%, 8.7%, 8.6%, 8.5%, 8%, 7.5%, etc.); (4) for nylon pick cords having a total denier of 1501-2000, the EASL at 44 N is at most 11.5% (e.g., 11.5%, 11.4%, 11.3%, 11.2%, 11.1%, 11%, 10.5%, 10%, 9.5%, 9%, etc.), preferably no more than 11% (e.g., 11%, 10.9%, 10.8%, 10.7%, 10.6%, 10.5%, 10%, 9.5%, 9%, etc.) or no more than 10% (e.g., 10%, 9.9%, 9.8%, 9.7%, 9.6%, 9.5%, 9%, etc.); (5) for nylon pick cords having a total of denier is 2001-3000, the EASL at 66 N is at most 9.5% (e.g., 13%, 12.5%, 12%, 11.5%, 11%, 10.5%, 10%, 9.5%, 9.4%, 9.3%, 9.2%, 9.1%, 9%, 8.5%, 8%, 7.5%, etc.), preferably no more than 12.5% (e.g., 12.5%, 12%, 11.5%, 11%, 10.5%, 10%, 9.5%, 9%, 8.9%, 8.8%, 8.7%, 8.6%, 8.5%, 8%, 7.5%, etc.), or no more than 12% (e.g., 12.5%, 12%, 11.5%, 11%, 10.5%, 10%, 9.5%, 9%, 8.5%, 8.4%, 8.3%, 8.2%, 8.1%, 8%, 7.5%, etc.); (6) for nylon pick cords having a total denier of 3001-6000, the EASL at 88N is at most 9.5% (e.g., 9.5%, 9%, 8.5%, 8%, 7.5%, 7%, etc.), preferably no more than 9% (e.g., 9%, 8.5%, 8%, 7.5%, 7%, etc.), or no more than 8.5% (e.g., 8.5%, 8%, 7.5%, 7%, etc.); (7) for hybrid pick cords (e.g., aramid+nylon) having a total denier of 2001-3000, the EASL at 66N is at most 4% (e.g., 4%, 3.5%, 3%, 2.5%, etc.), preferably at most 3.5% (e.g., 3.5%, 3%, 2.5%, etc.); (8) for hybrid pick cords (e.g., aramid+nylon) having a total denier of 3001-4000, the EASL at 66N is at most 3% (e.g., 3%, 2.5%, 2%, etc.), preferably at most 2.5% (e.g., 2.5%, 2%, etc.). EASL refers to elongation at a specified load and provides a measure of the dimensional stability of the cord or its resistance to stretch under load. The EASL values referred to herein can be determined according to ASTM Method D885/D885M. In certain embodiments of the first embodiment, the single steel cord-containing belt further comprises (also includes) pick cords connecting the steel warp cords and steel weft cords, the pick cords having an EASL according to any one of (1)-(8), above.

According to the first and second embodiments, the elongation at break (Eb) and tensile strength or tensile at break (Tb) of the pick cords may vary. The elongation at break refers to the percentage elongation that can be reached before the final filament(s) of the cord break(s) and the tensile at break refers to the amount of force required to break the final filament(s) of the cord. In certain embodiments of the first and second embodiments, the pick cords have an Eb of no less than 5% (e.g., 5%, 6%, 7%, 8%, 9%, 10%, etc.). In certain embodiments of the first and second embodiments, the pick cords have an Eb of 5% to about 30%, 5-30% (e.g., 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, or 30%), about 7% to about 25%, 7-25% (e.g., 7%, 8%, 9%, 10%, 11%, 12%, 13%, 14%, 15%, 16%, 17%, 18%, 19%, 20%, 21%, 22%, 23%, 24%, or 25%), 5 to about 20%, or 5-20% (e.g., 5%, 6%, 7%, 8%, 9%, 10%, 11%, 12%, 13%, 14%, 15%, 16%, 17%, 18%, 19%, 20%). While Eb can be determined by various methods, the Eb values referred to herein are measured according to ASTM Method D885 or Method D2256 (single strand). The Eb values reported herein for the pick cord can be determined using a modified version of ASTM Method D2256 wherein a 25 mm segment of pick cord is placed in an Instron machine and force is applied to elongate the cord; the elongation at break or Eb can be determined using the graph generated by the machine by marking the point at which resistance of the cord ceased due to complete breaking of the cord filaments. The % elongation can then be determined using that elongation length and comparing it to the starting length (i.e., 25 mm). As a non-limiting example, if the cord started at 25 mm in length and point marked on the graph was 75 mm then the Eb would be 200%.

In certain embodiments of the first and second embodiments, the pick cords have a Tb of at least 125 N. In certain embodiments of the first and second embodiments, the pick cords have a Tb of 125-250 N (e.g., 125, 130, 135, 140, 145, 150, 155, 160, 165, 170, 175, 180, 185, 190, 195, 200, 205, 210, 215, 220, 225, 230, 235, 240, 245, or 250 N), about 140 to about 250 N, or 140-250 N (e.g., 140, 145, 150, 155, 160, 165, 170, 175, 180, 185, 190, 195, 200, 205, 210, 215, 220, 225, 230, 235, 240, 245, or 250 N). While Tb can be determined by various methods, the Tb values referred to herein are measured according to ASTM Method D2256. In certain embodiments of the first and second embodiments, the pick cords have an Eb according to one of the foregoing values or ranges in combination with a Tb according to one of the foregoing values or ranges.

According to the first and second embodiments, the diameter of the pick cords in the steel cord-containing ply may vary in different steel cord-containing plies. However, generally, within a given ply the diameter of the pick cords will be the same. In certain embodiments of the first and second embodiments, the diameter of the pick cords is about 0.3 to about 0.8 mm. In certain embodiments of the first and second embodiments, the diameter of the pick cords is 0.3-0.8 mm (e.g., 0.3, 0.35, 0.4, 0.45, 0.5, 0.55, 0.6, 0.65, 0.7, 0.75, or 0.8 mm), about 0.4 to about 0.7 mm, or 0.4 to 0.7 mm (e.g., 0.4, 0.45, 0.5, 0.55, 0.6, 0.65, or 0.7 mm).

According to the first and second embodiments, the denier of the pick cords may vary. In certain embodiments of the first and second embodiments, the pick cords are made of filaments having a denier per filament of 600-2000 (e.g., 600, 700, 800, 900, 1000, 1100, 1200, 1300, 1400, 1500, 1600, 1700, 1800, 1900, or 2000), preferably 800-1400; in certain such embodiments, the pick cords have a total denier of 600-6000 (e.g., 600, 700, 800, 900, 1000, 1100, 1200, 1300, 1400, 1500, 1600, 1700, 1800, 1900, 2000, 2100, 2200, 2300, 2400, 2500, 2600, 2700, 2800, 2900, 3000, 3500, 4000, 4500, 5000, 5500, or 6000), preferably a total denier of 800-3000, or 800-2600. In preferred embodiments of the first and second embodiments, the pick cords have a circular cross-section. In other embodiments of the first and second embodiments, the pick cords have a substantially circular cross-section by which is meant that their width and thickness vary by no more than 10% (e.g., 10%, 9%, 8%, 7%, 6%, 5%, 4%, 3%, 2%, or 1%).

According to the first and second embodiments, the spacing of the pick cords in the steel cord-containing ply may vary in different steel cord-containing plies. However, generally, within a given ply the spacing between pick cords will be the same. In certain embodiments of the first and second embodiments, the spacing between pick cords is such that there are about 2 to about 9 picks/dm (wherein dm is an abbreviation for decimeter). In certain embodiments of the first and second embodiments, the spacing of the pick cords is 2-9 picks/dm (e.g., 2, 3, 4, 5, 6, 7, 8 or 9 picks/dm), about 3 to about 8 picks/dm, or 3 to 8 picks/dm (e.g., 3, 4, 5, 6, 7, or 8 picks/dm).

In certain preferred embodiments of the first and second embodiments, the pick cords within the steel cord-containing ply are non-intersecting to each other. In other words, the pick cords are positioned within the steel cord-containing ply in substantially parallel arrangement such that within the ply they do not cross over or intersection each other along their length. In certain embodiments of the first and second embodiments, each pick cord can be described as positioned parallel to the other pick cords within the steel cord-containing ply.

In certain preferred embodiments of the first and second embodiments, the pick cords of the steel cord-containing ply are positioned at an acute angle of greater than 50 degrees to the steel warp cords. Preferably, according to the first and second embodiments, the pick cords of the steel cord-containing ply are positioned at an angle of about 56 to about 74 degrees, 56-74 degrees (e.g., 56, 58, 60, 62, 64, 66, 68, 70, 72, or 74 degrees), more preferably about 58 to about 72 degrees, or 58-72 degrees (e.g., 58, 60, 62, 64, 66, 68, 70, or 72 degrees).

According to the first and second embodiments, the angle at which the pick cords are oriented in a given ply may vary, although within a given ply the pick cords will generally be parallel to each other (and, thus, all at the same angle within the given ply). Preferably, according to the first and second embodiments, the pick cords are oriented in the ply at an angle near the circumferential direction of travel of the tire. In certain embodiments of the first and second embodiments, the pick cords are oriented in the ply at angle of no more than +/−10 degrees (e.g., +10, +9, +8, +7, +6, +5, +4, +3, +2, +1, −10, −9, −8, −7, −6, −5, −4, −3, −2, or −1 degrees) from the circumferential direction of travel of the tire. In other embodiments of the first and second embodiments, the pick cords are oriented in the ply at angle of no more than +/−5 degrees (e.g., +5, +4.5, +4, +3.5, +3, +2.5, +2, +1.5, +1, +0.5, −5, −4.5, −4, −3.5, −3, −2.5, −2, −1.5, −1, or −0.5 degrees) from the circumferential direction of travel of the tire.

According to the first and second embodiments, pick cords suitable for use in the steel cord-containing play may be constructed of various materials. Generally, within a given steel cord-containing ply the pick cords will all be made of the same material(s). In certain embodiments of the first and second embodiments, the pick cords are each comprised of at least one synthetic filament. By stating that the pick cords are each comprised of at least one synthetic filament is meant that the material used for the pick cords may be one synthetic material or more than one synthetic material. In such embodiments, the pick cords may be referred to as synthetic pick cords. In certain embodiments of the first and second embodiments, the pick cords are comprised of at least one synthetic material selected from nylon, polyester, rayon, aramid, or combinations thereof. As a non-limiting example, a combination thereof would be nylon-aramid. In certain embodiments of the first and second embodiments, the pick cords are made from one synthetic filament. In other embodiments of the first and second embodiments, the pick cords are made from more than one synthetic filament (e.g., two, three, four, five or more filaments) which may be twisted or wrapped together in various configurations.

According to the first and second embodiments disclosed herein, the spacing between the steel warp cords may vary. In certain embodiments of the first and second embodiments, the spacing between the steel warp cords is about 0.3 to about 4 mm, 0.3 to 4 mm (e.g., 0.3, 0.5, 0.8, 1, 1.3, 1.5, 1.8, 2, 2.3, 2.5, 2.8, 3, 3.3, 3.5, 3.8, or 4 mm), preferably about 0.35 to about 3 mm, or 0.35-3 mm (e.g., 0.35 mm, 0.5 mm, 0.7 mm, 1 mm, 1.2 mm, 1.5 mm, 1.7 mm, 2 mm, 2.2 mm, 2.5 mm, 2.7 mm, or 3 mm).

In certain embodiments of the first embodiment, the tire comprises a belt component with a single (i.e., only one) steel cord-containing ply according to the present invention. In other embodiments of the first embodiment, the tire comprises a belt component with two steel cord-containing plies. When two steel cord-containing plies are utilized in the tire according to the first embodiment, each ply is preferably present in the same belt component. Alternatively, in other embodiments of the first and according to the second embodiment, each ply is present in a separate belt component. In those embodiments of the first and second embodiments wherein the two plies are present in the same belt component, a rubber layer separates each ply such that the steel cords of each ply are not in direct contact. In those embodiments of the first and second embodiments wherein each of the two plies is present in a separate belt component, each ply is separately rubber reinforced, as discussed further herein.

### Tires

As discussed above, the first and second embodiments disclosed herein are directed to a vehicle tire including a carcass with at least one body ply, a tread disposed radially outward of the carcass, and at least one belt component comprising a steel cord-containing ply positioned radially between the tread and the carcass. According to the first and second embodiments, the particular configuration of the at least one body ply may vary. In certain embodiments of the first and second embodiments, the tire comprises one body ply of rubber-covered cords. In other embodiments, the tire comprises more than one body ply of rubber-covered cords (e.g., two, three, four, or more). Generally, the tire will also include a pair of annular beads with the body ply wrapped circumferentially within the tire and extending from bead to bead (and in certain embodiments extending around the beads). In certain embodiments of the first and second embodiments, the tire further comprises an inner liner and the body ply is positioned radially outward of the inner liner; in certain such embodiments the body ply is adjacent to the inner liner with no intervening layer(s) between and in other such embodiments the body ply is separated from the inner liner by one or more intervening layers. In certain instances, the body ply of the first and second embodiments can be described as a carcass ply. As used herein, a carcass ply refers to a ply positioned radially inward in the tire and also comprises a layer comprising rubber-covered cords, generally textile cords; in certain tires one or more carcass plies are utilized and are positioned such that they extend from bead to bead in the tire with their respective cords positioned radially or diagonally (i.e., not circumferentially). When more than one carcass ply is utilized, each may be positioned such that their cord direction differs (e.g., biased to each other). As non-limiting examples, exemplary vehicle tires according to the first embodiment may comprise the following components (listed in order from radially outward to radially inward): Tire 1: tread, one belt component with a steel cord-containing ply, at least one body ply or carcass ply, inner liner; Tire 2: tread, one belt component with two steel cord-containing plies, at least one body ply or carcass ply, inner liner; Tire 3: tread, two belt components, each with a steel cord-containing ply, at least one body ply or carcass ply, inner liner.

In certain embodiments of the first and second embodiments, the tire comprises (includes) a single (i.e., only one) steel cord-containing ply. In other embodiments of the first and second embodiments, the tire comprises (includes) more than one (preferably, two) steel cord-containing plies. In certain such embodiments, the two steel cord-containing plies are positioned adjacent to each other within the tire. In other words, one ply is radially outward of the other with no other intervening layers. In certain embodiments of the first and second embodiments wherein the tire contains two steel cord-containing plies, the first steel cord-containing ply is positioned in the tire with its steel warp cords at a first angle about 58 to 72 degrees, or at 58-72 degrees (e.g., 58, 59, 60, 61, 62, 63, 64, 65, 66, 67, 68, 69, 70, 71, or 72 degrees) from the direction of circumferential travel of the tire and the second steel cord-containing ply is positioned in the tire with its steel warp cords at a second angle which is about 180 degrees+the first angle, or which is 180 degrees+/−no more than 5 degrees (i.e., +/−5, +/−4, +/−3, +/−2, +/−1 or +/−0 degrees). In those embodiments of the first and second embodiments wherein the tire contains one steel cord-containing ply, the steel cord-containing ply is positioned in the tire with its steel cords at an angle as discussed above for the “first angle.” As a non-limiting example, designating the direction of circumferential forward travel of the tire as 0 degrees, and designating increasing degrees of orientation in a clock-wise direction, the first steel cord-containing ply could be positioned in the tire with its steel warp cords at an angle of 60 and the second steel cord-containing ply could be positioned in the tire with its steel warp cords at an angle of 180 degrees+the first angle (i.e., 240 degrees). (The discussion of various aspects of the “steel cord-containing ply” contained herein generally should be understood to apply equally to embodiments wherein one steel cord-containing ply is present as well as those embodiments wherein two steel cord-containing plies are present.)

### Processes for Preparing the Steel Warp Cords and Pick Cords

Various weaving processes can be utilized to prepare the combination of steel warp cords and pick cords which are included in the steel cord-containing ply or plies of the first and second embodiments. In certain embodiments, the weaving comprises the use of a loom. The particular configuration of the loom as well as its components, and the weaving process may vary. In certain embodiments, one or more of the following are met: (1) the loom comprises a plurality of rolls containing the warp cords (these rolls may be mounted onto a creel or beam roll), (2) the warp cords pass from the creel through a guide (which may include an eye board and/or guide bars) which positions them parallel to each other, (3) after passing through the guide the warp cords pass through another guide (reed guide) where the pick cords are inserted, (4) after addition of the pick cords, the material passes onto a guide roll or rolls, (5) after the guide roll or rolls the material is wound onto a roll for storage or shipment, (6) during the weaving process on the loom tension is maintained upon the warp cords and the material by use of multiple feed and/or guide rolls which can assist in maintaining alignment of the tire cords.

### Producing the Steel Cord-Containing Ply

As discussed above, the steel cord-containing ply may be produced by a process which includes adding a covering of rubber on the top and bottom surface of the material containing the steel warp cords and pick cords, thereby producing a steel cord-containing ply with rubber covered cords, as described above. Such processes comprise providing the material including the steel warp cords and the pick cords (as described above) which has a top and bottom surface and covering each of the top and bottom surfaces of the material with rubber, thereby producing a rubber covered ply. As discussed above, the particular composition of the rubber used for the covering may vary and certain details are provided above.

The particular process used to cover the material which includes the steel warp cords and the pick cords with rubber may vary. In certain embodiments, the covering (i.e., covering of the cords with rubber) comprises calendaring with sheets of rubber; in certain such embodiments two sheets of rubber are utilized with one sheet applied to the top surface and the second sheet applied to the bottom surface. In certain such embodiments, the calendaring is performed using a creel calendar. In other embodiments, the covering (i.e., covering of the top and bottom surfaces of the cord material with rubber) comprises extruding of material with the rubber.

The thickness of the rubber sheet(s) used to cover the cord material may vary. In certain embodiments of the fourth embodiment, the rubber sheet(s) used to cover the steel cord-containing ply has/have a thickness as discussed above. Traditionally, after tire cords have been covered with rubber (e.g., by calendaring) to produce a ply, at least a majority or even all of the pick cords are intentionally broken. Breakage of the pick cords allows for uniform expansion and flexing of the rubber covered tire ply during the tire building process and can be especially important when the pick cords are made from a relatively inextensible or of relatively low modulus material (e.g., cotton) which is not sufficiently stretchy and/or strong to otherwise allow the expansion and flexing of the ply that is necessary during tire building without breaking. Utilization of the pick cords as described herein provides for increased strength in the steel cord-containing ply and allows for elimination of the step of breaking the pick cords. Accordingly, in certain embodiments of the first and second embodiments, the steel cord-containing ply has at least 95% of its pick cords unbroken (when the ply is incorporated into the tire and/or in the finished tire). In other embodiments, at least 90% to 100% (e.g., 90%, 91%, 92%, 93%, 94%, 95%, 96%, 97%, 98%, 99%, 99.5% or 100%), including at least 90% to 99.5%, at least 90% to 99%, at least 90% to 98%, at least 90% to 95%, at least 92% to 100%, at least 92% to 99.5%, at least 92% to 99%, at least 92% to 98%, at least 95% to 100%, at least 95% to 99.5%, at least 95% to 99%, at least 95 to 98%, at least 96% to 100%, at least 96% to 99.5%, at least 96% to 99%, at least 96% to 98%, at least 97% to 100%, at least 97% to 99.5%, or at least 97% to 99% of the pick cords of the steel cord-containing ply of the first and second embodiments is unbroken.

### Examples

The following examples illustrate specific and exemplary embodiments and/or features of the embodiments of the present disclosure. The examples are provided solely for the purposes of illustration and should not be construed as limitations of the present disclosure. Numerous variations over these specific examples are possible without departing from the spirit and scope of the presently disclosed embodiments. It should be understood that components other than those listed below in Examples 1-3 can be utilized to in tires according to the first and second embodiments. More specifically, it should be understood that steel warp cords having different properties (e.g., diameter, spacing, construction, etc.) as well as pick cords having different properties (e.g., diameter, spacing, construction, etc.) from those used in the below example (i.e., as fully as disclosed in the preceding paragraphs) can be utilized.

A single steel cord-containing ply is constructed using the following components:

TABLE 1

| | diameter | | | | | | |
|---|---|---|---|---|---|---|---|
| | (mm) | construction | spacing | material | EASL | Eb | Tb |
| Warp | 0.65 | 1 × 3 | 50 epdm | steel | | No more | 630 N |
| cords | | | (1.34 mm) | | | than 7% | |
| Pick | 0.60 | 1260/2 | 100 epdm | Nylon | 7% | 16% | 205 N |
| cords | | (denier) | (0.39 mm) | | | | |

The single steel cord-containing ply also includes a rubber covering of approximately 0.1-0.2 mm (cured gauge) over the top and the bottom surfaces of the warp and pick cords. The overall thickness of the single steel cord-containing ply is 2-2.5 mm (cured gauge). The single steel cord-containing ply is incorporated into a tire for use on a passenger tire.

This application discloses several numerical range limitations that support any range within the disclosed numerical ranges, even though a precise range limitation is not stated verbatim in the specification, because the embodiments of the compositions and methods disclosed herein could be practiced throughout the disclosed numerical ranges. With respect to the use of substantially any plural or singular terms herein, those having skill in the art can translate from the plural to the singular or from the singular to the plural as is appropriate to the context or application. The various singular or plural permutations may be expressly set forth herein for sake of clarity.

It will be understood by those within the art that, in general, terms used herein, and especially in the appended claims are generally intended as “open” terms. For example, the term “including” should be interpreted as “including but not limited to,” the term “having” should be interpreted as “having at least,” the term “includes” should be interpreted as “includes but is not limited to.” It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” All references, including but not limited to patents, patent applications, and non-patent literature are hereby incorporated by reference herein in their entirety. While various aspects and embodiments of the compositions and methods have been disclosed herein, other aspects and embodiments will be apparent to those skilled in the art. The various aspects and embodiments disclosed herein are for purposes of illustration and are not intended to be limiting, with the true scope and spirit being indicated by the claims.

What is claimed is:

1. A vehicle tire including a carcass with at least one body ply, a tread disposed radially outward of the carcass and a belt component comprising a steel cord-containing ply positioned radially between the tread and the carcass,
the steel cord-containing ply comprising rubber reinforced with steel warp cords having a diameter of about 0.3 to about 7 mm, the steel warp cords connected with pick cords having an EASL according to one of the following:
(a) for PET pick cords having a total denier up to 2000, an EASL at 44 N of at most 4%;
(b) for PET pick cords having a total denier of 2001-3000, an EASL at 66 N of at most 5%;
(c) for nylon pick cords having a total denier up to 1500, an EASL at 33 N of at most 9.5%;
(d) for nylon pick cords having a total denier of 1501-2000, an EASL at 44 N of at most 11.5%;
(e) for nylon pick cords having a total of denier is 2001-3000, an EASL at 66 N of at most 9.5%;
(f) for nylon pick cords having a total denier of 3001-6000, an EASL at 88N of at most 9.5%;
(g) for hybrid pick cords having a total denier of 2001-3000, an EASL at 66N of at most 4%; or
(h) for hybrid pick cords having a total denier of 3001-4000, an EASL at 66N of at most 3%,
wherein the steel warp cords are non-intersecting.

2. The vehicle tire of claim 1, wherein the pick cords meet at least one of the following:
a. an elongation at break of no less than 5%; or
b. a tensile strength Tb of at least 125 N.

3. The vehicle tire of claim 1, wherein the pick cords are positioned substantially perpendicular to the steel warp cords.

4. The vehicle tire of claim 1, wherein spacing between the steel warp cords is about 0.3 to about 4 mm.

5. The vehicle tire of claim 1, wherein the pick cords have a diameter of about 0.3 to about 0.8 mm.

6. The vehicle tire of claim 1, wherein spacing between the pick cords is about 2 to about 9 picks/dm.

7. The vehicle tire of claim 1, wherein the pick cords are comprised of at least one synthetic filament.

8. The vehicle tire of claim 7, wherein the at least one synthetic filament comprises nylon, polyester, aramid, rayon, or a combination thereof.

9. The vehicle tire of claim 1, wherein the steel warp cords have a construction of M×N where M is an integer of 1 to 7, and N is either an integer of 2-10 or selected from (O+P) where O is an integer of 1-4 and P is an integer of 5 to 15.

10. The vehicle tire of claim 1 comprising a single steel cord-containing ply.

11. The vehicle tire of claim 1 comprising two steel cord-containing plies.

12. The vehicle tire of claim 11, wherein the first steel cord-containing ply is positioned in the tire with its steel warp cords at a first angle of about 56 to about 74 degrees from the direction of circumferential travel of the tire and the second steel cord-containing ply is positioned in the tire with its steel warp cords at a second angle which is about 180 degrees+the first angle.

13. A vehicle tire including a carcass with at least one body ply, a tread disposed radially outward of the carcass and two belt components comprising a steel cord-containing ply, each belt component positioned radially between the tread and the carcass,
the steel cord-containing ply comprising rubber reinforced with steel warp cords having a diameter of about 0.3 to about 7 mm,
the steel warp cords connected with pick cords having an EASL according to one of the following:
(a) for PET pick cords having a total denier up to 2000, an EASL at 44 N of at most 4%;
(b) for PET pick cords having a total denier of 2001-3000, an EASL at 66 N of at most 5%
(c) for nylon pick cords having a total denier up to 1500, an EASL at 33 N of at most 9.5%;
(d) for nylon pick cords having a total denier of 1501-2000, an EASL at 44 N of at most 11.5%;
(e) for nylon pick cords having a total of denier is 2001-3000, an EASL at 66 N of at most 9.5%;
(f) for nylon pick cords having a total denier of 3001-6000, an EASL at 88N of at most 9.5%;
(g) for hybrid pick cords having a total denier of 2001-3000, an EASL at 66N of at most 4%; or
(h) for hybrid pick cords having a total denier of 3001-4000, an EASL at 66N of at most 3%,
wherein the steel warp cords are non-intersecting.

14. The vehicle tire of claim 13, wherein the pick cords meet at least one of the following:
a. an elongation at break of no less than 5%;
b. a tensile strength Tb of at least 125 N;
c. are positioned substantially perpendicular to the steel warp cords;
d. have a diameter of about 0.3 to about 0.8 mm;
e. spacing between the pick cords is about 2 to about 9 picks/dm.

15. The vehicle tire of claim 13, wherein spacing between the steel warp cords is about 0.3 to about 4 mm.

16. The vehicle tire of claim 13, wherein the pick cords are comprised of at least one synthetic filament.

17. The vehicle tire of claim 16, wherein the at least one synthetic filament comprises nylon, polyester, aramid, rayon, or a combination thereof.

18. The vehicle tire of claim 13, wherein the steel warp cords have a construction of M×N where M is an integer of 1 to 7, and N is either an integer of 2-10 or selected from (O+P) where O is an integer of 1-4 and P is an integer of 5 to 15.

19. The vehicle tire of claim 13 comprising a single steel cord-containing ply.

20. A vehicle tire including a carcass with at least one body ply, a tread disposed radially outward of the carcass and a belt component comprising a steel cord-containing ply positioned radially between the tread and the carcass,
the steel cord-containing ply comprising rubber reinforced with steel warp cords having a diameter of about 0.3 to about 7 mm, the steel warp cords connected with pick cords having an EASL according to one of the following:
(a) for PET pick cords having a total denier up to 2000, an EASL at 44 N of at most 4%;
(b) for PET pick cords having a total denier of 2001-3000, an EASL at 66 N of at most 5%;
(c) for nylon pick cords having a total denier up to 1500, an EASL at 33 N of at most 9.5%;
(d) for nylon pick cords having a total denier of 1501-2000, an EASL at 44 N of at most 11.5%;
(e) for nylon pick cords having a total of denier is 2001-3000, an EASL at 66 N of at most 9.5%;
(f) for nylon pick cords having a total denier of 3001-6000, an EASL at 88N of at most 9.5%;
(g) for hybrid pick cords having a total denier of 2001-3000, an EASL at 66N of at most 4%; or
(h) for hybrid pick cords having a total denier of 3001-4000, an EASL at 66N of at most 3%,
wherein the steel warp cords are non-intersecting and have a spacing between the steel warp cords of about 0.3 to about 4 mm,
wherein the pick cords are positioned substantially perpendicular to the steel warp cords, are comprised of at least one synthetic filament, have a diameter of about 0.3 to about 0.8 mm, and have a spacing between the pick cords of about 3 to about 8 picks/dm.
